(19) United States
(12) Patent Application Publication
(10) Pub. No.: US 2012/0239541 A1
(43) Pub. Date: Sep. 20, 2012

(54) ACTIONABLE ALERTING

(75) Inventors: Carl TSUKAHARA, Piedmont, CA (US); Terri Prince, Santa Rosa, CA (US)

(73) Assignee: ClairMail, Inc., San Rafael, CA (US)

(21) Appl. No.: 13/423,574

(22) Filed: Mar. 19, 2012

Related U.S. Application Data
(60) Provisional application No. 61/454,469, filed on Mar. 18, 2011.

(51) Int. Cl. G06Q 40/00

(52) U.S. Cl. 705/35

(57) ABSTRACT

A technique involves processing a first event, maintaining state associated with the event, sending an alert on a stateless communication channel to a registered destination of an account holder associated with the event, processing a second event such as an expected response to the alert, updating the maintained state, and closing, reminding, or escalating in response to the second event. The technique can also include aggregation of events.

### BACKGROUND

Users of credit cards, banks, and other financial tools can benefit from being alerted of certain activities related to their accounts. When an event, and in particular a suspicious event, occurs, it can be desirable to alert the user of the event. Such alerts can be, for example, alerts regarding suspected fraud. Typically, such alerts can include a request that the user call a hotline to inform a party that the event is non-fraudulent (because the transaction was made by the user) or that the user is not aware of the transaction having taken place. It is also possible to alert users that an account is low on funds or that overdraft protection was used.

One problem with the current alerts is that they must be used on stateful communication channels, such as through a website. While it is possible to send an alert for which a response can be made via some other channel, it is not typically possible to send an alert via a stateless communication channel, and receive a response via that same stateless communication channel. For example, an SMS alert that funds are low in a first account would not enable a user to respond via the same channel by transferring money to the first account. Rather, the user receiving the alert would have to log in to a banking website, call a customer service representative (CSR), or the like and transfer the funds through the other communication channel.

The foregoing examples of the related art and limitations related therewith are intended to be illustrative and not exclusive. Other limitations of the related art will become apparent upon a reading of the specification and a study of the drawings.

### SUMMARY

In various examples, one or more of the above-described problems have been reduced or eliminated, while other examples are directed to other improvements. The following examples and aspects thereof are described and illustrated in conjunction with systems, tools, and methods that are meant to be exemplary and illustrative, not limiting in scope.

A technique for actionable alerting involves processing a first event, maintaining state associated with the event, sending an alert on a stateless communication channel to a registered destination of an account holder associated with the event, processing a second event, updating the maintained state, and closing, reminding, or escalating in response to the second event. The technique can also include aggregation of events.

Advantageously, the technique enables utilization of stateless channels for both alerting and receiving responses from account holders. This facilitates more rapid resolutions for events. Since state is maintained, a system implementing the technique can handle multiple events simultaneously for a single account holder or state model, even using stateless channels.

### BRIEF DESCRIPTION OF THE DRAWINGS

FIG. 1 depicts an example of an actionable alerting system.

FIG. 2 depicts a flowchart of an example of a method for maintaining issue state during pendency of an issue.

FIG. 3 depicts a flowchart of an example of a method for aggregating alerts.

FIG. 4 depicts a flowchart of an example of a method for actionable aggregated event alerting.

FIG. 5 depicts a flowchart of an example of a method for actionable event alerting on a stateless communication channel.

FIG. 6 depicts an example of a state model data structure.

FIG. 7 depicts a system on which an actionable alerting system can be implemented.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

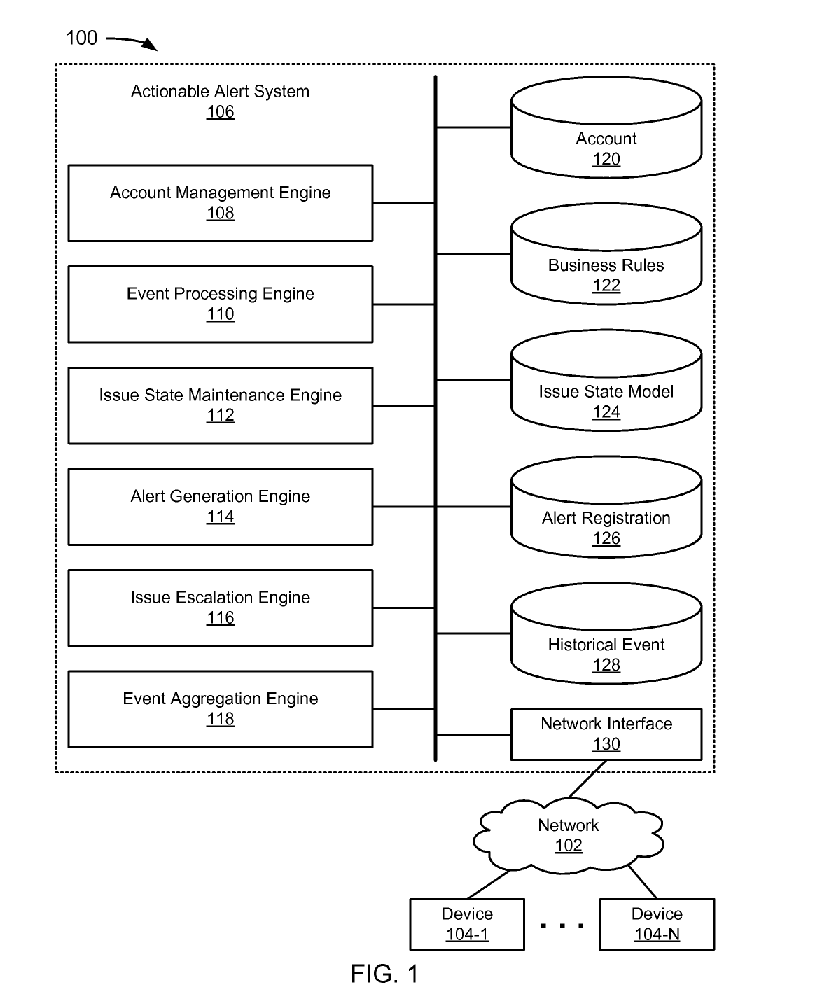

FIG. 1 depicts an example of a system 100 including a network 102, devices 104-1 to 104-N (collectively, devices 104), and an actionable alert system 106. In the example of FIG. 1, the network 102 can include a networked system that includes several computer systems coupled together, such as a local area network (LAN), the Internet, or some other networked system. The term “Internet” as used in this paper refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being on the Internet. A web server, which is one type of content server, is typically at least one computer system which operates as a server computer system and is configured to operate with the protocols of the World Wide Web and is coupled to the Internet. Applicable known or convenient physical connections of the Internet and the protocols and communication procedures of the Internet and the web are and/or can be used. The network 102 can broadly include, as understood from relevant context, anything from a minimalist coupling of the components illustrated in the example of FIG. 1, to every component of the Internet and networks coupled to the Internet. However, components that are outside of the control of the actionable alert system 106 can be considered sources of data received in an applicable known or convenient manner.

In the example of FIG. 1, the devices 104 can be implemented as computer systems coupled to the network 102. A computer system will usually include a processor, memory, non-volatile storage, and an interface. Peripheral devices can also be considered part of the computer system. A typical computer system will include at least a processor, memory, and a device (e.g., a bus) coupling the memory to the processor. The processor can include, for example, a general-purpose central processing unit (CPU), such as a microprocessor, or a special-purpose processor, such as a microcontroller. The memory can include, by way of example but not limitation, random access memory (RAM), such as dynamic RAM (DRAM) and static RAM (SRAM). The memory can be local, remote, or distributed. The term “computer-readable storage medium” is intended to include physical media, such as memory.

The bus can couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The bus can also couple the processor to one or more interfaces. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

In one example of operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

In the example of FIG. 1, the actionable alert system 106 includes an account management engine 108, an event processing engine 110, an issue state maintenance engine 112, an alert generation engine 114, an issue escalation engine 116, an event aggregation engine 118, an account datastore 120, a business rules datastore 122, an issue state model datastore 124, an alert registration datastore 126, a historical event datastore 128, and a network interface 130. The actionable alert system 106 can be implemented on one or more devices in a network. Networks can include enterprise private networks and virtual private networks (collectively, private networks), which are well known to those of skill in computer networks. As the name suggests, private networks are under the control of an entity rather than being open to the public. Private networks can include a head office and optional regional offices (collectively, offices). Many offices enable remote users to connect to the private network offices via some other network, such as the Internet. It may be desirable for some or all of the components of the actionable alert system 106 to be implemented on a private network.

As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure.

The account management engine 108 can create account holder accounts and storing data associated with the accounts in the account datastore 120. The account holders can include humans and constructive entities (e.g., corporations, associates, etc.). In this paper, where the account holder takes some action, it should be understood that the action is that of a human performing tasks, such as data input on one of the devices 104, and an artificial agent (e.g., a specially purposed computer) performing tasks on behalf of the account holder. The account creation procedure can include applicable convenient techniques, such as accepting account holder data via a web interface that include fields for receiving data from a user. Accounts can also be created in batch fashion, such as by creating accounts for a list of bank customers. Account holder information can vary depending upon the implementation, but will at least include a unique identifier (e.g., credit card account number, checking account number, userid, etc.), and it is likely to be useful to have both one or more account numbers and a userid. Where the account management engine 108 is implemented by, e.g., a financial institution within a private network, the account datastore 120 can include a great deal of private data. Where the account management engine 108 is implemented by a third party providing a service to, e.g., a financial institution, the data maintained can be more limited.

The account management engine 108 can receive input from an account holder. For the purposes of this example, it is generally assumed that input from an account holder is through one of the devices 104. The data can include an alert destination, which the account management engine 108 stores in the alert registration datastore 126. Advantageously, the alert destination can be the destination that results in the fastest possible response time from the account holder, whether that is email, phone, short messaging service (SMS), or some other destination address.

The account management engine 108 can also manage financial institution accounts. For example, the account management engine 108 can manage both banking customers and the banking institution. The financial institution can provide business rules, which the account management engine 108 stores in the business rules datastore 122. Alternatively, the business rules could be maintained without input from the financial institution. Depending upon the implementation, account holders can be allowed to opt in or out of certain business rules applications.

The event processing engine 110 is coupled to the account management engine. An event can be generally described as a message related to an account that is received at or generated by the actionable alert system 106. The exact nature of possible events can vary depending upon the implementation. For example, a message regarding the use of a credit card is applicable to a system that is implemented in association with a credit card issuer, while a message regarding a check order being placed is applicable to a system that is implemented in association with a check issuer. For illustrative simplicity, examples provided in this paper are typically for credit card issuers and banks, though techniques may be applicable to other types of institutions, as well, such as telephone companies, governmental entities, utilities, brokerage houses, stores, websites, casinos, or the like. Depending upon the context, the event can also be a response to a previously sent actionable alert. Depending upon the implementation, the event can include messages generated within the actionable alert system 106, such as a message that alerts have been aggregated and not sent for some period of time, escalation result alerts, account update alerts, and the like.

The event processing engine 110 can identify an account in the account datastore 120 with which an event is associated. For events that are generated internally, this may be an inherent task (e.g., a periodic account notification might be generated in association with an account, obviating the need to identify the account after the event is generated). For events that are incoming into the actionable alert system 106, however, the account with which the event is associated must typically be identified. The event processing engine 110 can identify the accounts by checking a field of the event that has account information (e.g., a credit card number), parsing the event to identify relevant information (e.g., a credit card number that is not stored in a known field), applying business rules from the business rules datastore 122 to identify the account, or the like. It may be noted that, depending upon implementation-, configuration, and/or event-specific details, an event can be associated with one or more accounts, but for illustrative simplicity, the events are described in this paper as being associated with one account. That is, “identifying an account with which an event is associated” may or may not mean identifying one or more accounts with which an event is associated.

The event processing engine 110 can make a business rules determination as to how to further process the first event using the business rules in the business rules datastore 122. As was mentioned above, the business rules may or may not also assist in identifying the account with which the event is associated. To the extent events are received in an expected format, the business rules can be relatively straight-forward. For example, if an account is associated with a credit card and a credit card transaction event is received, the format of the event can include the credit card number, a transaction amount, date, location, and available credit. If the transaction amount is greater than available credit, the business rules can indicate the event is a “threshold exceeded event.” As another example, the account datastore 120 might include the available credit, and the business rules can indicated the event is a “threshold exceeded event” by comparing the transaction amount to the available credit value that is stored in the account datastore 120. As another example, the event could be received from a credit card issuer, indicating that an account holder has exceeded available credit, without including the transaction details, and the event processing engine 110 can generated a “threshold exceeded event” by reliance upon the credit card issuer's assertion that the threshold was exceeded.

The event processing engine 110 can determine that an alert is not necessary for an event. In some implementations, historical data is recorded for all events, while in others historical data is recorded for only a subset of events. (It is also possible that historical data is not maintained for any events.) The event processing engine 110 stores the historical data in the historical event datastore 128.

The event processing engine 110 can use historical events for later-processed events. For example, if a first event of a credit card transaction in Canada is stored in the historical event datastore 128 and a second event a few hours later is of a credit card transaction in South Africa, the business rules can flag the second event (or first event, or both events) as suspicious transactions.

The event processing engine 110 can use time-specific information about an account holder when processing an event. For example, the account management engine 108 could receive an indication from an account holder who is normally in the United States that they will be in Japan on a certain date. A transaction that takes place in Japan will not be particularly suspicious given the user update. Account holders could also grant access to the location of their smart phone, which would be useful for determining whether a card-present transaction is co-located with the phone at a point-of-sale (POS).

The issue state maintenance engine 112 is coupled to the event processing engine 110. The issue state maintenance engine 112 generates a state model according to the business rules determination of the event processing engine 110 and stores the state model in the issue state model datastore 124. An issue state model includes an account identifier and the status of an issue. The state model is critical in implementations that include actionable alerting on a stateless communication channel, as explained below.

The alert generation engine 114 is coupled to the issue state maintenance engine 112. The alert generation engine 114 finds in the alert registration datastore 126 an alert destination address for an account for which the business rules determination indicates an alert is needed. Particularly if the alert destination address is associated with a stateless communication channel, the alert generation engine 114 determines an expected response to the alert and generates an alert that includes a value sufficient to identify the expected response. The alert generation engine 114 sends the alert to the alert destination. The issue state maintenance engine 112 can update the state model to include expected responses for the issue. If the event processing engine 110 later receives a second event that includes the value sufficient to identify the expected response, the issue state maintenance engine 112 can then update the state model in accordance with the received expected response.

The alert generation engine 114 can generate an alert for an event received after issue state has been stored. The second alert can be a reminder. When sending a reminder, the issue escalation engine 116 may or may not also escalate the issue. The alert generation engine 114 can also send an alert that the associated issue is being closed or expedited. The alert generation engine 114 can also send aggregated alerts when an aggregation alert threshold is passed, as described below.

Advantageously, the alert generation engine 114 can generate multiple alerts for an account for transmission on a stateless communication channel, and the event processing engine 110 can process the responses using the received expected responses. The multiple alerts can be for the same issue for the account (e.g., suspicious transaction alerts in various locations) or for unrelated issues for the account (e.g., an account overdraft protection alert and a change of contact information alert). This would not normally be possible because responses over a stateless communication channel would not be tied to a specific issue or alert. Persistent state is necessary for actionable alerting, and the issue state model provides such persistent state.

Advantageously, an account holder can respond to an alert by replying to push notification or SMS. For example, an account holder who gets a suspicious transaction alert could contest the transaction on the same media channel through which the alert was received.

Advantageously, the risk of SMS phishing (SMiShing) is reduced when actionable alerting is implemented via SMS. An account holder can respond with a short (often as short as a single key stroke) message. There is no need for the account holder to ever respond via an alternate channel (e.g., by calling a phone number in the SMS message or visiting a website in the SMS message). So account holders can be informed that they will never be told to do so, reducing the probability that account holders will fall victim to a SMiShing scam.

The issue escalation engine 116 is coupled to the alert generation engine 114. Some events may trigger an escalation response automatically. For example, a very large suspicious transaction could trigger a response that involves contacting other parties to obtain additional account information, transaction information, or the like. Some events can trigger an alert, but not trigger escalation unless a particular response is received from the account holder (or no response is received within a particular time frame). For example, if an account holder responds that they are responsible for a suspicious transaction within a certain time frame, the issue escalation engine 116 may not initiate an escalated response.

The issue escalation engine 116 can trigger an escalation that depends upon the implementation. Typical escalations include notifying a customer support representative (CSR) in a call center to follow up with the account holder, requesting additional data from another system (e.g., account transaction, balance info, additional transaction, status of other fraud case, etc.), or the like. Some escalations are more implementation-specific. For example, account holders could be informed of secret emergency responses that will cause the issue escalation engine 116 to initiate a ‘911’ call (potentially because an account holder is accosted at an automated teller machine (ATM)). As another example, an alert response could trigger checking whether an issue has been resolved in another system. As another example, an alert response could trigger locking or unlocking a car or building.

The issue escalation engine 116 can also trigger an escalation based upon time passing. For example, an issue could be expired based upon the lack of a response for a certain period of time.

The issue escalation engine 116 can trigger an escalation based upon the issue state when receiving an alert. For example, if issue state for a suspicious transaction is pending when another suspicious transaction event is received, the issue escalation engine 116 might escalate to a higher level.

The event aggregation engine 118 is coupled to the issue escalation engine 116. Alerts stored for aggregation can be referred to as “aggregated alerts.” The event aggregation engine 118 stores aggregated alerts in the historical event datastore 128. Since the aggregated alerts are not closed, an associated issue state model is stored in the issue state model datastore 124. Aggregated alerts may or may not be for the same issue; different alerts in a set of aggregated alerts can be associated with different issue states. However, because the aggregated alerts are sent to the same alert destination, it will typically be the case that each of the aggregated alerts is related to the same account at least indirectly.

Aggregated alerts can start with a single alert, to which the event aggregation engine 118 can add additional alerts. So an aggregated alert can have a single alert. An aggregated alert with a single alert may even be sent to an alert destination if the event aggregation engine 118 aggregates alerts for a period of time, but does not receive an applicable second event in that time period. When it is desirable to clarify that an aggregated alert includes multiple alerts, the aggregated alert can be referred to as an aggregated alert of multiple alerts. The presumption is that an aggregated alert will always have at least one alert.

The event aggregation engine 118 can aggregate events that were stored in the historical event datastore 128 without storing an associated state model in the issue state model datastore 124. Some events might not rise to the level of an alert, and are not considered sufficiently problematic to merit storing issue state. However, a later-received event may increase the likelihood that a historical event was a problematic one. For example, if two credit card transactions are done in Mexico with an account holder's card, and the account holder updates location a few minutes later to indicate they are in Germany, the historical events may rise to the level of an alert. The event aggregation engine 118 can then aggregate the two transaction events in Mexico and send an alert.

The account datastore 120, business rules datastore 122, issue state model datastore 124, alert registration datastore 126, and historical event datastore 128 store information useful to the engines to implement the functionality described above.

The network interface 130 can include an applicable hardware interface that enables the actionable alert system 106 to communicate with an account holder associated with one or more of the devices 104 via the network 102. All communication channels by which the actionable alert system 106 and the devices 104 are operationally connected are treated as passing through the network interface 130, even if certain communication channels are through different hardware ports. That is, the network interface 130 can comprise multiple different interfaces.

In the example of FIG. 1, in operation, the account management engine 108 stores account holder information in the account datastore 120, and modifies the account holder information when it is changed or updated, if applicable.

The event processing engine 110 receives an event, associates the event with the account holder, and applies business rules from the business rules datastore 122 to the event to determine how to further process the event. If the event is an expected alert response for an issue that has a corresponding state model saved in the issue state model datastore 124, the event processing engine 110 can process the event according to the expected alert response. In general, the event processing engine 110 can determine to alert (or remind), escalate, close, aggregate, or archive. If it is determined the event needs no further processing (archive), the event processing engine 110 can store the event and/or relevant data in the historical event datastore 128.

For each other business rule determination, alert (or remind), escalate, close, or aggregate, the issue state maintenance engine 112 can initialize an issue state, if there is no corresponding state model saved in the issue state model datastore 124, or update the corresponding state model stored in the issue state model datastore 124. Multiple state models can be simultaneously stored for the same account holder.

The alert generation engine 114 identifies in the alert registration datastore 126 a destination address for an alert for the account holder. The alert generation engine 114 determines an expected response to an alert associated with the first event, generates an alert that includes a value sufficient to identify the expected response, and sends the alert to the destination. The alert generation engine 114 can generate multiple alerts for the same issue, and the issue state maintenance engine 112 can maintain the state for each of the alerts in the issue state model datastore 124. The alert generation engine 114 can send multiple alerts on a stateless communication channel for an account holder, even when a later-sent alert is sent prior to receiving a response to a previously sent alert from the account holder.

The issue escalation engine 116 escalates an issue in accordance with the business rules determination. Escalations can include notifying a CSR in a call center, sending a reminder through another channel, account, device, or party, expiring a conversation based on response or no response, requesting additional data from another system, checking whether an issue was resolved in another system, locking/unlocking a door, calling the police, or the like.

The event aggregation engine 118 aggregates alerts in accordance with the business rules determination. When a triggering event is received by the event processing engine 110, such as an nth event when aggregating n alerts or an aggregation timer expires, the business rules determination can be to send the aggregated alert and the alert generation engine 114 can send the aggregated alert.

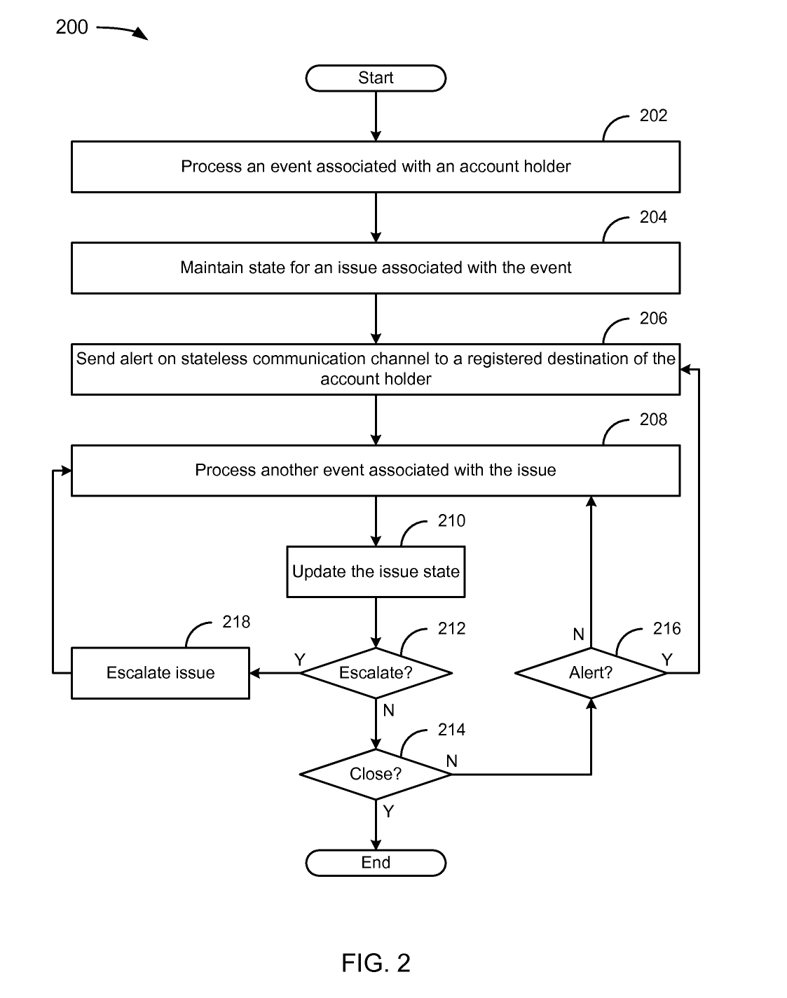

FIG. 2 depicts a flowchart 200 of an example of a method for maintaining issue state during pendency of an issue. This flowchart and other flowcharts are depicted in the figures of this paper as serially arranged modules. However, modules of the flowcharts may be reordered or arranged for parallel execution as appropriate.

To the extent techniques are presented in this paper in terms of algorithms and symbolic representations of operations on data bits within a computer memory. These algorithmic descriptions and representations are used by those skilled in computer science to convey substance to others skilled in the art. An algorithm is here, and generally, conceived to be a self-consistent sequence of operations leading to a desired result. The algorithms can be implemented on computer systems with instructions to configure the computer systems in a specific manner in accordance with the teachings described in this paper as specifically purposed computer systems, or it may prove convenient to construct specialized apparatus to perform the some embodiments. Algorithms implemented on computer systems require physical manipulations of physical quantities, resulting in the transformation of data. Usually, though not necessarily, these quantities take the form of electrical or magnetic signals capable of being stored, transferred, combined, compared, and otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise in this paper, discussions utilizing terms such as “processing,” “computing,” “calculating,” “determining,” “displaying,” “generating,” “identifying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the example of FIG. 2, the flowchart 200 starts at module 202 with processing an event associated with an account holder. The event can be internally generated (e.g., timer expiration event), received from a third party such as point-of-sale (e.g., a credit card transaction event from a store) or a financial institution (e.g., overdraft protection event from a bank), or received from an account holder (e.g., an expected response to an alert or account update). Event processing includes identifying the account with which the event is associated and making a business rules determination regarding how to further process the event. The business rules determination can include archive, aggregate, alert, or escalate. If issue state exists for the event, the alert determination can be a determination to send a reminder and the archive determination can be a determination to close the issue. In some implementations and/or for certain issues, archival can be replaced with deletion.

In the example of FIG. 2, the flowchart 200 continues to module 204 with maintaining state for an issue associated with the event. Certain business rules determinations call for maintaining state. For example, an archive decision does not require maintenance of state because there is no associated alert, aggregation requires maintenance of state, but it can be internal (e.g., a counter that generates an event when the requisite number of events have been aggregated or a timer that generates an event when the requisite amount of time has passed for aggregating certain events), and an alert requires maintenance of state to ensure that the alert can be sent on a stateless communication channel, such as SMS. State should also be maintained when escalating to ensure that the status of the issue is updated as it is escalated.

In the example of FIG. 2, the flowchart 200 continues to module 206 with sending an alert on a stateless communication channel to a registered destination of the account holder. Since state was maintained (204), it becomes possible to send an alert to an account holder on a stateless communication channel. If no state were maintained, an alerting system might not be able to reconcile an event that was a response to an alert through the stateless communication channel. Distinguishing between multiple outstanding alerts for a single account holder becomes impossible on a stateless communication channel without ensuring that the responses are within prescribed parameters. So the alert can include expected responses such that a response from the account holder can be matched with the alert.

In the example of FIG. 2, the flowchart 200 continues to module 208 with processing another event associated with the issue. When an event is received that is associated with an issue that has issue state, the event can be relatively redundant (perhaps resulting in a reminder alert or archival without additional alerts), or dispositive (perhaps resulting in closing or escalating the issue).

In the example of FIG. 2, the flowchart 200 continues to module 210 with updating the issue state. Even where an event is relatively redundant, issue state can be updated to indicate that a reminder was sent on a certain date, or that an event was processed but the state is relatively unchanged. Alternatively, certain redundant events might be processed without updating state.

In the example of FIG. 2, the flowchart 200 continues to decision point 212 where it is determined whether to escalate the issue. If it is determined that escalation is not necessary (212-N), then the flowchart 200 continues to decision point 214 where it is determined whether to close the issue. If it is determined to close the issue (214-Y), then the flowchart 200 ends with the state having been updated (210) to closed. On the other hand, if it is determined to not close the issue (214-N), then the flowchart 200 continues to decision point 216 where it is determined whether to send another alert. If it is determined to send another alert (216-Y) then the flowchart returns to module 206 and continues as described previously with the state having been updated (210) to remain open with a reminder alert being sent (206). On the other hand, if it is determined to not to send an alert (216-N) then the flowchart returns to module 208 and continues as described previously with the state having been updated (210) to remain open.

Referring once again to decision point 212, if it is determined to escalate (212-Y), then the flowchart 200 continues to module 218 with escalating the issue. How an issue is escalated is largely implementation-specific, but can include sending an alert on another channel, notifying a CSR in a call center, requesting additional data from another system, or the like. The flowchart 200 then continues to module 208 as described previously, but with state being updated to reflect the escalation. The presumption of the example of FIG. 2 is that the escalation generates another event associated with the issue (which is processed at module 208). It is possible that the flowchart 200 would instead return to module 208 with sending another alert, depending upon the implementation and/or how the issue was escalated. It is also possible that the flowchart 200 would instead return to module 210 with updating the issue state to reflect the results of the escalation, possibly resulting in further escalation at decision point 212. It is also possible that the flowchart 200 would instead return to decision point 214 where it would be determined whether to close the issue in response to the escalation. It is also possible that the flowchart 200 would instead return to decision point 216 with determining whether to send another alert (associated with the “another event” or with the results of the escalation).

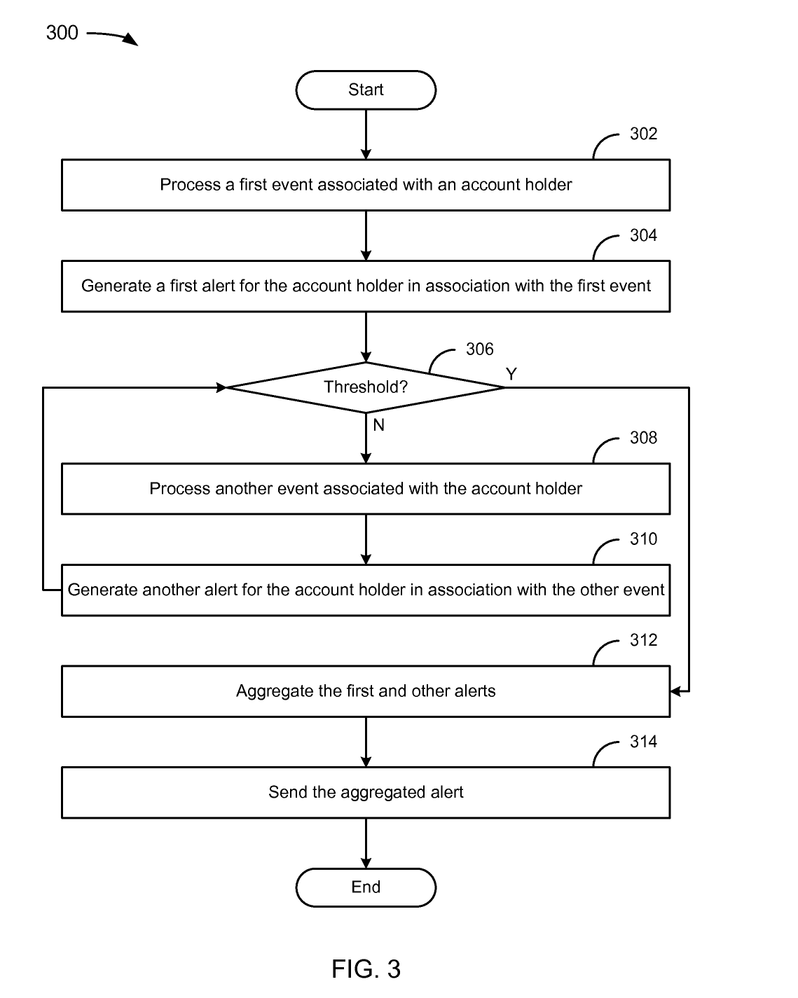

FIG. 3 depicts a flowchart 300 of an example of a method for aggregating alerts. The example of FIG. 2 does not explicitly illustrate alert aggregation. The example of FIG. 3 is intended to illustrate how alerts can be aggregated.

In the example of FIG. 3, the flowchart 300 starts at module 302 with processing a first event associated with an account holder. The event can be internally generated, received from a third party such as point-of-sale or a financial institution, or received from an account holder.

In the example of FIG. 3, the flowchart 300 continues to module 304 with generating a first alert for the account holder in association with the first event. Since the first alert is going to be aggregated, it is possible in an alternative implementation to archive the event and store a state model for the issue with which the event is associated, but not actually generate an alert until it is time to send the aggregated alert.

In the example of FIG. 3, the flowchart 300 continues to decision point 306 with determining whether an aggregation threshold has been met. The aggregation threshold can include a timer that starts when the first event is received or processed or that restarts at the start of a time frame (e.g., daily). The aggregation threshold can include a counter that counts the number of events received and the threshold is reached when the counter matches the number of events that have been received. The combination of a timer and counter is also possible (e.g., generate an aggregated alert when the earlier of the counter threshold and the timer threshold are met).

If it is determined that the aggregation threshold has not been met (306-N), then the flowchart 300 continues to module 308 with processing another event associated with the account holder and to module 310 with generating another alert for the account holder in association with the other event, and returns to decision point 306. The loop (306 to 310) repeats until the aggregation threshold is met (306-Y). The first and other events may or may not be associated with the same issue, depending upon the implementation, configuration, and/or other factors, but in some implementations the first and other events are associated with the same issue. It may be noted that it is possible for the other events to be null, such as when the aggregation threshold is met before events received after the first event are processed. In this case, the first alert could be sent as a delayed alert or, more explicitly, as an alert for which aggregation was attempted but for which aggregation was not accomplished.

When it is determined that the aggregation threshold has been met (306-Y), the flowchart 300 continues to module 312 with aggregating the first and other alerts. The “other alerts” can be referred to as a second set of alerts (if it is desirable to show that the aggregation may or may not have been successful, since a set includes the null set) or as including a second alert (if it is desirable to show that the aggregated alert includes at least a first alert and a second alert).

In the example of FIG. 3, the flowchart 300 ends at module 314 with sending the aggregated alert. It may be noted that the end of the flowchart 300 does not necessarily correspond to closing an issue (or with any other disposition of the issue state other than to indicate that an aggregated alert was sent).

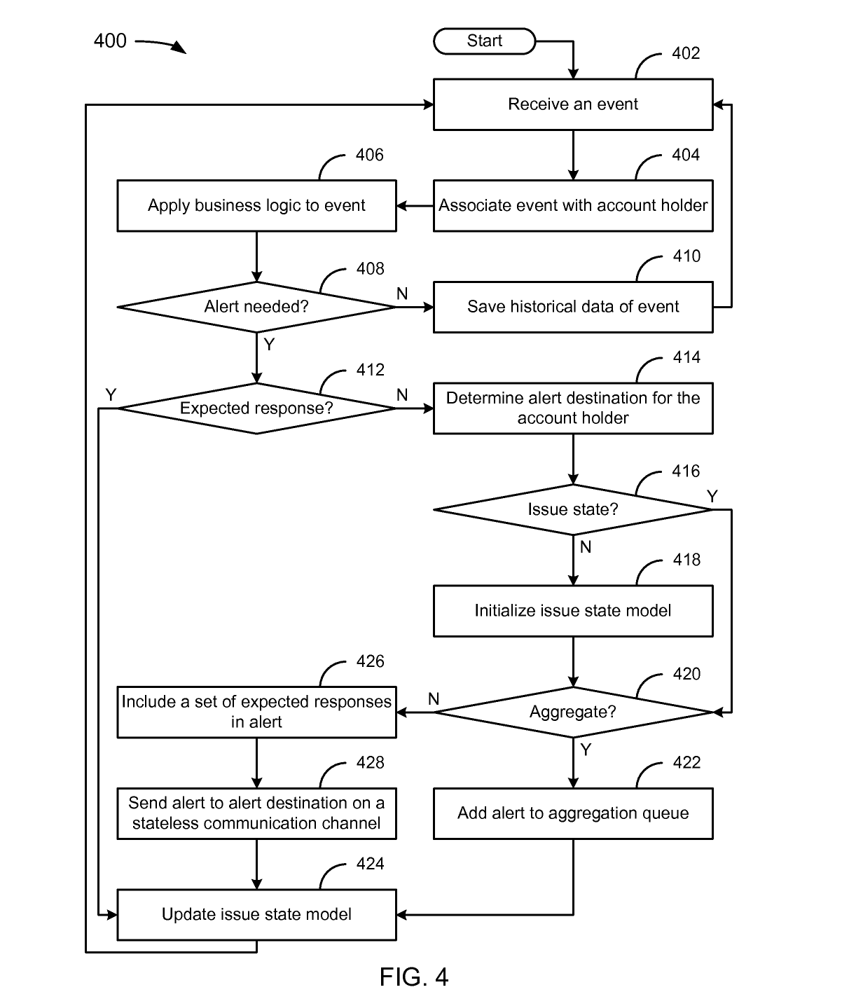

FIG. 4 depicts a flowchart 400 of an example of a method for actionable aggregated event alerting. In the example of FIG. 4, the flowchart 400 starts at module 402 with receiving an event. The event can be internally generated, received from a third party such as point-of-sale or a financial institution, or received from an account holder.

In the example of FIG. 4, the flowchart 400 continues to module 404 with associating the event with an account holder and to module 406 with applying business logic to the event. The application of business logic results in a business logic determination that can be used at various decision points of the flowchart 400.

In the example of FIG. 4, the flowchart 400 continues to decision point 408 where it is determined whether an alert is needed for the event. Whether an alert is needed will depend upon the business logic determination, and can include user configurations, financial institution preferences, and/or logic that determines how important the event in a given context (e.g., identifying fraud, enabling overdraft protection, or the like). If it is determined that an alert is not needed for the event (408-N), then the flowchart 400 continues to module 410 with saving historical data of the event and returns to module 402 as described previously. For illustrative purposes in this example, a business determination to aggregate alerts is a determination that an alert is needed for the event (408-Y). It may be noted that saving historical data of the event (410) is often desirable, but may or may not be done in certain implementations, in accordance with account holder preferences, and/or for certain events.

If it is determined that an alert is needed for the event (408-Y), then the flowchart 400 continues to decision point 412 where it is determined whether an expected response has been received. Where a first event is received (before issue state has been initialized) the first event will not be in accordance with an expected response. It is possible to maintain state for multiple issues; so each issue can have a “first event” that will not include an expected response. It is possible to receive multiple events associated with the same issue before an expected response is received, as well. If it is determined that an expected response has been received (412-Y), then the flowchart 400 continues to module 424, which will be described later.

If, on the other hand, it is determined that an expected response has not been received (412-N), then the flowchart 400 continues to module 414 with determining an alert destination for the account holder and to decision point 416 where it is determined whether an issue state model is being maintained for the issue associated with the event. If it is determined that issue state is not being maintained (416-N), then the flowchart 400 continues to module 418 with initializing an issue state model and to decision point 420 where it is determined whether to aggregate alerts. If, on the other hand, it is determined that issue state is being maintained (416-Y), then the flowchart 400 continues to decision point 420.

If it is determined to aggregate alerts (420-Y), then the flowchart 400 continues to module 422 with adding the alert to the aggregation queue and to module 424 with updating the issue state model. Then the flowchart 400 returns to module 402 and continues as described previously. One of the events received (402) can include an indication that the aggregation threshold has been met, in which case it will be determined not to aggregate additional alerts (420-N) and an aggregated alert can be sent.

If it is determined not to aggregate alerts (420-N), then the flowchart 400 continues to module 426 with including a set of expected responses in an alert and to module 428 with sending the alert to the alert destination, and returns to module 424 and continues as described previously. Expected responses can include, assuming the communication medium is text, such as SMS, one or more characters that form a unique response within the context of the pending issues for the account holder. For example, a response of “A” is unique if the account holder has no other pending issues for which an “A” is responsive. In an implementation, multiple uses of the same expected response might be possible (e.g., if one alert is a reminder of another alert or if a second alert is aggregated with the first alert). The alert destination is an address on a stateless communication channel. The alert destination will typically be an address provided by or for an account holder, and in a specific implementation the address can be on a variety of media (e.g., SMS, email, or the like).

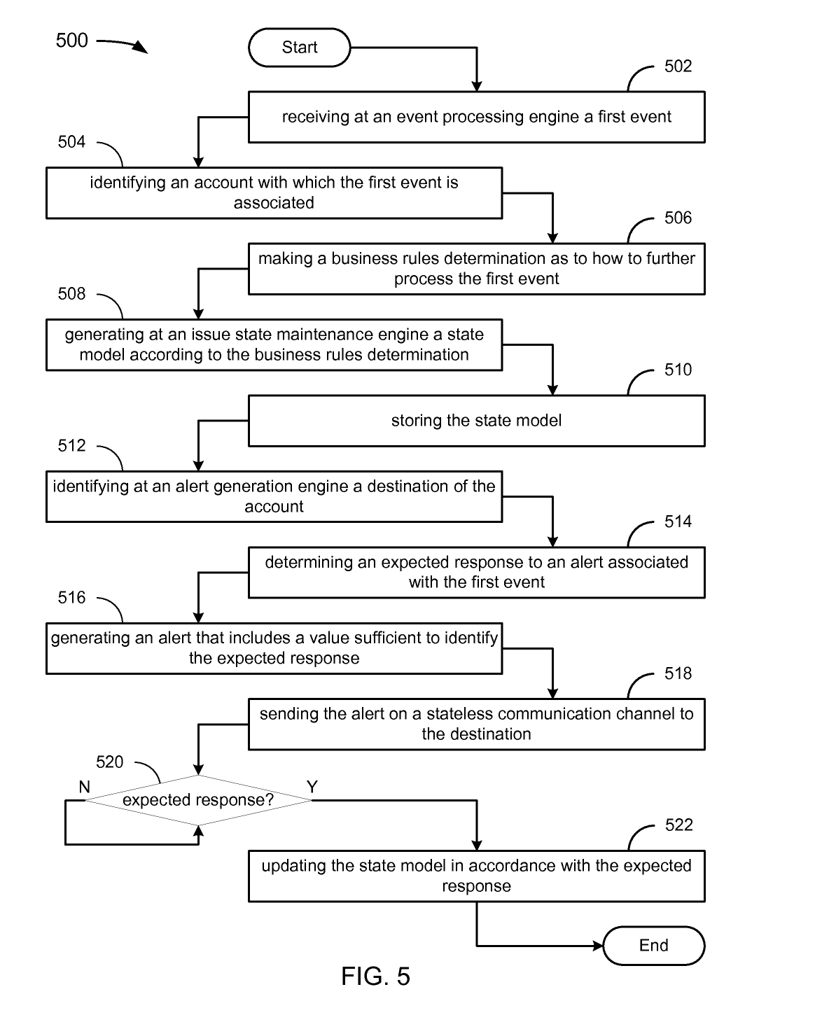

FIG. 5 depicts a flowchart 500 of an example of a method for actionable event alerting on a stateless communication channel. In the example of FIG. 5, the flowchart 500 starts at module 502 with receiving at an event processing engine a first event. (See, e.g., FIG. 1, event processing engine 110.)

In the example of FIG. 5, the flowchart 500 continues to module 504 with identifying an account with which the first event is associated. (See, e.g., FIG. 1, event processing engine 110, account datastore 120.)

In the example of FIG. 5, the flowchart 500 continues to module 506 with making a business rules determination as to how to further process the first event. (See, e.g., FIG. 1, event processing engine 110, business rules datastore 122.)

In the example of FIG. 5, the flowchart 500 continues to module 508 with generating at an issue state maintenance engine a state model according to the business rules determination. (See, e.g., FIG. 1, issue state maintenance engine 112, issue state datastore 124.)

In the example of FIG. 5, the flowchart 500 continues to module 510 with storing the state model. (See, e.g., FIG. 1, issue state maintenance engine 112, issue state datastore 124.)

In the example of FIG. 5, the flowchart 500 continues to module 512 with identifying at an alert generation engine a destination of the account. (See, e.g., FIG. 1, alert generation engine 114, alert registration datastore 126.)

In the example of FIG. 5, the flowchart 500 continues to module 514 with determining an expected response to an alert associated with the first event. (See, e.g., FIG. 1, alert generation engine 114.)

In the example of FIG. 5, the flowchart 500 continues to module 518 with generating an alert that includes a value sufficient to identify the expected response. (See, e.g., FIG. 1, alert generation engine 114.)

In the example of FIG. 5, the flowchart 500 continues to module 518 with sending the alert on a stateless communication channel to the destination. (See, e.g., FIG. 1, alert generation engine 114.)

In the example of FIG. 5, the flowchart 500 continues to decision point 520 where it is determined whether the expected response has been received. If it is determined that the expected response has not been received (520-N), then the flowchart 500 waits for an event that includes the expected response or a value sufficient to identify the expected response. It may be noted that this likely has nothing to do with any wasted computational cycles, but is rather a conceptual illustration of the delay between when the alert is sent and a response is received. It should be noted that the flowchart 500 can end without receiving the expected response, and presumably would if the expected response were not received for a relatively long period of time (not shown).

When it is determined that the expected response has been received (520-Y), the flowchart 500 ends at module 522 with updating the state model in accordance with the expected response. The flowchart 500 thus illustrates an event-alert-response cycle for a single event (or two events if the response is treated as an event).

Multiple issues can be processed simultaneously by the same method as illustrated in the example of FIG. 5. While it is possible to relate issues that are initially unrelated (e.g., a pay-at-the-pump event could be first issue with a first state and a suspicious transaction could be a second issue with a second state, and later when it is determined that both transactions were potentially made by the same fraudulent party, the events could be combined into a single issue with a single issue state), issues are generally treated as distinct. Thus, the expected response for a first issue should be different from the expected response for a second issue.

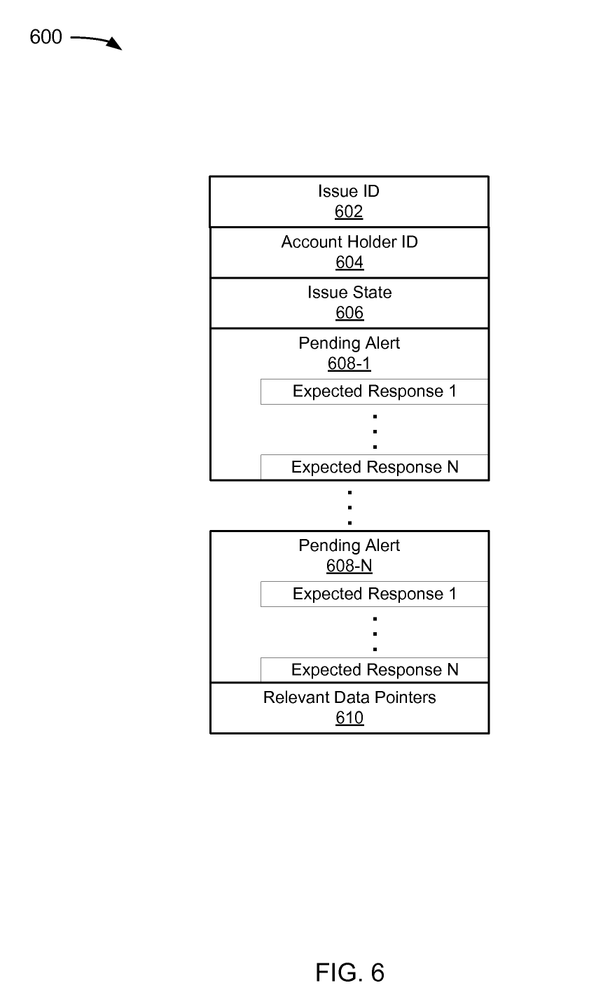

Data structures are data that has been stored in a format that may vary in an implementation-specific manner, but that includes characteristics and structure necessary to accomplish the intended function. With this in mind, FIG. 6 is intended to illustrate a state model data structure. One of skill in the art of computer science would recognize that other data structure formats are possible. In the example of FIG. 6, a state model data structure 600 includes an issue ID field 602, an account holder ID field 604, an issue state field 606, pending alert fields 608-1 to 608-N (collectively, the pending alert fields 608), and relevant data pointers 610.

The issue ID field 602 is a unique identifier of the issue state model. The account holder ID field 604 is a unique identifier of the account holder with which the issue state model is associated. It may be noted that the issue ID field 602 could be combined with the account holder ID to establish the uniqueness of the issue. That is, if the account holder has an ID “0000” and the issue has an ID of “1111,” even though some other account holder may also have an issue with an ID of “1111,” the combination of “11110000” is unique for a particular account holder and issue. So the issue ID need not necessarily be unique on its own relative to all other issue state models so long as its combination with some other field makes it unique.

The issue state field 606 includes a value sufficient to identify the general state of the issue state model. The general state can include “closed,” “pending,” and “escalated.” Other states can be added to increase the specificity of the issue state field 606 as desired.

When an event is processed, may or may not result in the generation of an issue state model, depending upon the implementation, configuration, the event or other data, and/or other factors. If it became desirable to track even issues that do not require state after initial processing, a general state of “archived” or similar state could be added to indicate that an event was received, but it was not necessary to maintain a state model for the associated issue. “Archived” is similar to “closed” in the sense that both do not necessarily have pending alerts. So, in order to capture both, one could use a state “resolved” to mean both initially archived and later closed issues.

When an issue is pending, there can be multiple more narrowly defined states than “pending.” For example, an issue could have a state of “once reminded” or “twice reminded” to indicate that one or more pending alerts for the issue are reminders or were followed by reminders. As another example, an issue that is going to be closed if no response is received within a certain time frame could be referred to as “dying.” As another example, a state that currently includes aggregated alerts that have not been sent could have the state “aggregating.” It is also possible for the issue state to be a combination of the various pending alerts associated with the issue.

When an issue has been escalated, there can be multiple more narrowly defined states than “escalated.” For example, an issue could have a state of “CSR” when the issue has been escalated to the notice of a CSR in a call center. The state could be “alternate channel” if escalation resulted in a reminder or contact attempt being made on another communication channel, such as a request to login to a website, email, or telephone call, and the specific channel could also be identified. The state could also be “awaiting response” if the escalation resulted in a request for data from another system that has not yet responded. The state could also be “emergency notification” if the escalation resulted in a notification of emergency or police personnel.

Each of the pending alert fields 608 can include an array of expected responses 1 . . . N. Expected responses can be identified by the characters that are an appropriate response and/or the action taken when the expected response is received. A pending alert can also be identified by an alert type, such as card not present, declined transaction, pay-at-the-pump, threshold exceeded, payees added, transaction verification, suspicious transaction, account open verification, check order placed, name/phone/address change, suspended account, or the like.

The relevant data pointers 610 point to data that is relevant to the issue, such as event data, previously sent alerts, previously received responses, related events, documents, data generated during escalation, or the like.

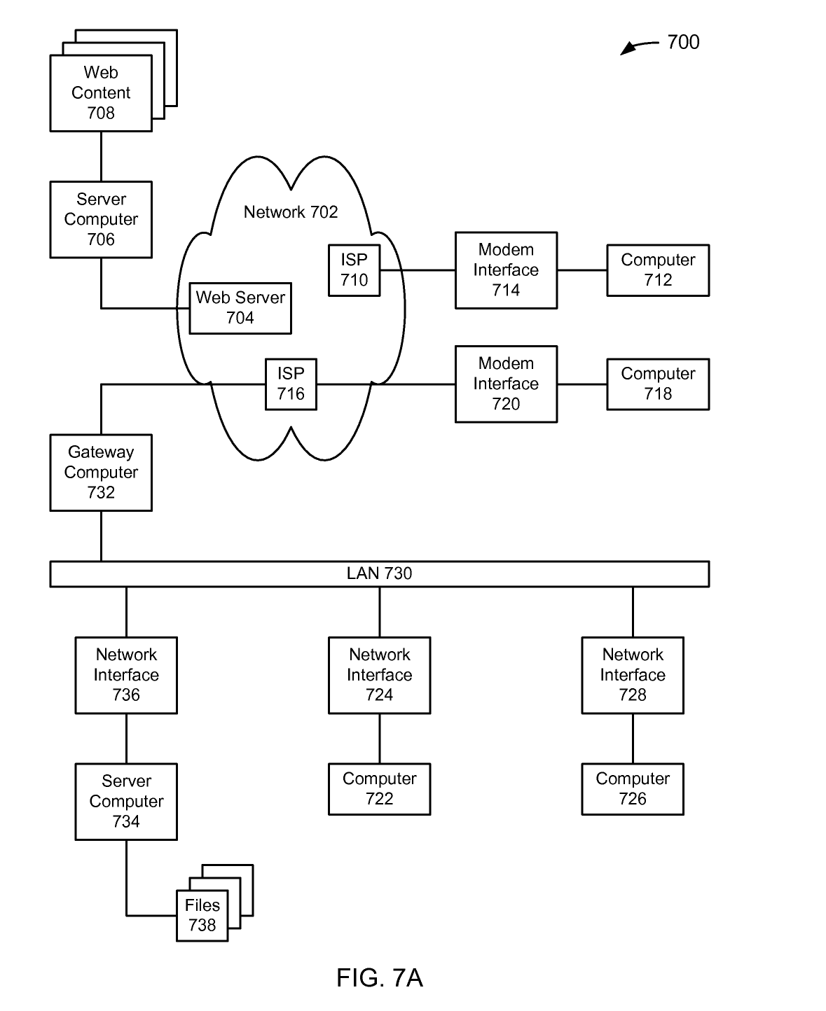

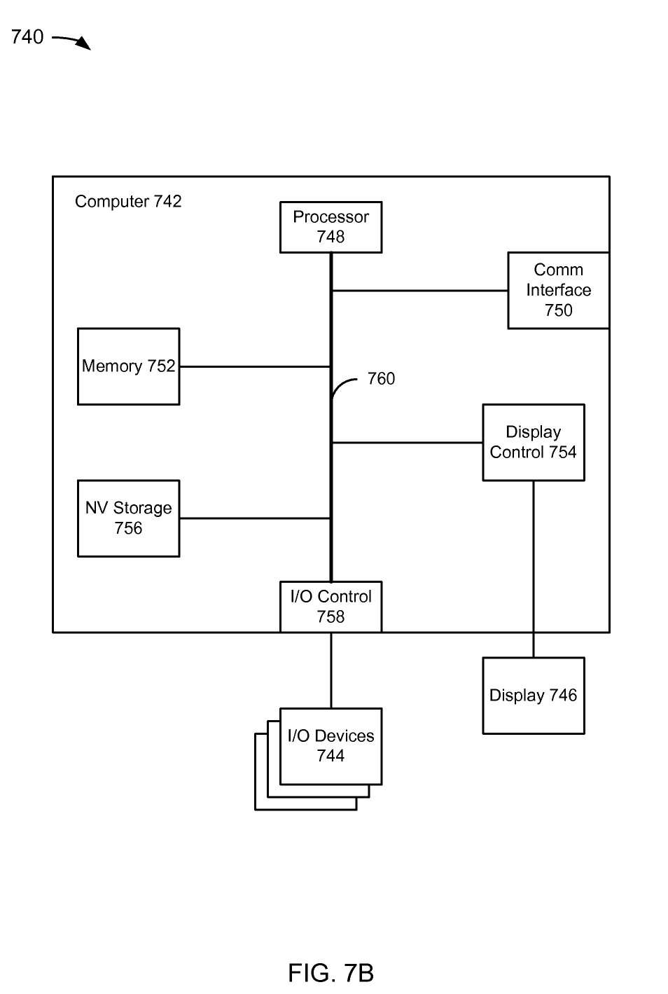

FIG. 7 depicts a system on which at least a portion of an actionable alert system can be implemented. FIG. 7 depicts a networked system 700 that includes several computer systems coupled together through a network 702, such as the Internet. The web server 704 is typically at least one computer system which operates as a server computer system and is configured to operate with the protocols of the world wide web and is coupled to the Internet. Optionally, the web server 704 can be part of an ISP which provides access to the Internet for client systems. The web server 704 is shown coupled to the server computer system 706 which itself is coupled to web content 708, which can be considered a form of media datastore. While two computer systems 704 and 706 are shown in FIG. 7, the web server system 704 and the server computer system 706 can be one computer system having different software components providing the web server functionality and the server functionality provided by the server computer system 706, which will be described further below.

Access to the network 702 is typically provided by Internet service providers (ISPs), such as the ISPs 710 and 716. Users on client systems, such as client computer systems 712, 718, 722, and 726 obtain access to the Internet through the ISPs 710 and 716. Access to the Internet allows users of the client computer systems to exchange information, receive and send e-mails, and view documents, such as documents which have been prepared in the HTML format. These documents are often provided by web servers, such as web server 704, which are referred to as being on the Internet. Often these web servers are provided by the ISPs, such as ISP 710, although a computer system can be set up and connected to the Internet without that system also being an ISP.

Client computer systems 712, 718, 722, and 726 can each, with the appropriate web browsing software, view HTML pages provided by the web server 704. The ISP 710 provides Internet connectivity to the client computer system 712 through the modem interface 714, which can be considered part of the client computer system 712. The client computer system can be a personal computer system, a network computer, a web TV system, or other computer system. While FIG. 7 shows the modem interface 714 generically as a “modem,” the interface can be an analog modem, isdn modem, cable modem, satellite transmission interface (e.g. “direct PC”), or other interface for coupling a computer system to other computer systems.

Similar to the ISP 714, the ISP 716 provides Internet connectivity for client systems 718, 722, and 726, although as shown in FIG. 7, the connections are not the same for these three computer systems. Client computer system 718 is coupled through a modem interface 720 while client computer systems 722 and 726 are part of a LAN 730.

Client computer systems 722 and 726 are coupled to the LAN 730 through network interfaces 724 and 728, which can include Ethernet or other network interfaces. The LAN 730 is also coupled to a gateway computer system 732 which can provide firewall and other Internet-related services for the local area network. This gateway computer system 732 is coupled to the ISP 716 to provide Internet connectivity to the client computer systems 722 and 726. The gateway computer system 732 can be a conventional server computer system.

Alternatively, a server computer system 734 can be directly coupled to the LAN 730 through a network interface 736 to provide files 738 and other services to the clients 722 and 726, without the need to connect to the Internet through the gateway system 732.

FIG. 7 depicts a computer system 740 for use in the system 700. The computer system 740 can be used as a client computer system or a server computer system or as a web server system, when specially purposed to fulfill the particular role. Such a computer system can be used to perform many of the functions of an Internet service provider, such as ISP 710. In the example of FIG. 7, the computer system 740 includes a computer 742, I/O devices 744, and a display device 746. The computer 742 includes a processor 748, a communications interface 750, memory 752, display controller 754, non-volatile storage 756, and I/O controller 758. The computer system 740 may be couple to or include the I/O devices 744 and display device 746.

The computer 742 interfaces to external systems through the communications interface 750, which may include a modem or network interface. It will be appreciated that the communications interface 750 can be considered to be part of the computer system 740 or a part of the computer 742. The communications interface can be an analog modem, ISDN modem, cable modem, token ring interface, satellite transmission interface (e.g. “direct PC”), or other interfaces for coupling a computer system to other computer systems.

The processor 748 may be, for example, a conventional microprocessor such as an Intel Pentium microprocessor or Motorola power PC microprocessor. The memory 752 is coupled to the processor 748 by a bus 760. The memory 752 can be dynamic random access memory (DRAM) and can also include static ram (SRAM). The bus 760 couples the processor 748 to the memory 752, also to the non-volatile storage 756, to the display controller 754, and to the I/O controller 758.

The I/O devices 744 can include a keyboard, disk drives, printers, a scanner, and other input and output devices, including a mouse or other pointing device. The display controller 754 may control in the conventional manner a display on the display device 746, which can be, for example, a cathode ray tube (CRT) or liquid crystal display (LCD). The display controller 754 and the I/O controller 758 can be implemented with conventional well known technology.

The non-volatile storage 756 is often a magnetic hard disk, an optical disk, or another form of storage for large amounts of data. Some of this data is often written, by a direct memory access process, into memory 752 during execution of software in the computer 742. Objects, methods, inline caches, cache states and other object-oriented components may be stored in the non-volatile storage 756, or written into memory 752 during execution of, for example, an object-oriented software program. In this way, the components illustrated in, for example, FIGS. 1-6 can be instantiated on the computer system 740.

The computer system 740 is one example of many possible computer systems which have different architectures. For example, personal computers based on an Intel microprocessor often have multiple buses, one of which can be an I/O bus for the peripherals and one that directly connects the processor 748 and the memory 752 (often referred to as a memory bus). The buses are connected together through bridge components that perform any necessary translation due to differing bus protocols.

Network computers are another type of computer system. Network computers do not necessarily include a hard disk or other mass storage, and the executable programs are loaded from a network connection into the memory 752 for execution by the processor 748. A typical computer system will usually include at least a processor, memory, and a bus coupling the memory to the processor.

In addition, the computer system 740 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 756 and causes the processor 748 to execute the various acts required by the operating system to input and output data and to store data in memory, including storing files on the non-volatile storage 756.

What is claimed is:

1. A system comprising:
an event processing engine;
an issue state maintenance engine coupled to the event processing engine;
an alert generation engine coupled to the issue state maintenance engine;
an account datastore coupled to the event processing engine;
an issue state model datastore coupled to the issue state maintenance engine;
an alert registration datastore coupled to the alert generation engine;
wherein, in operation:
the event processing engine:
receives a first event;
identifies an account in the account datastore with which the first event is associated;
makes a business rules determination as to how to further process the first event;
the issue state maintenance engine:
generates a state model according to the business rules determination;
stores the state model in the issue state model datastore;
the alert generation engine:
identifies a destination of the account in the alert registration datastore;
determines an expected response to an alert associated with the first event;
generates an alert that includes a value sufficient to identify the expected response;
sends the alert on a stateless communication channel to the destination;
wherein if the event processing engine later receives a second event that includes the value sufficient to identify the expected response, the issue state maintenance engine updates the state model in accordance with the expected response.

2. The system of claim 1, wherein the business rules determination is a first business rules determination, the state model is a first state model, the expected response is a first expected response, and the alert is a first alert:
wherein, in operation:
the event processing engine:
receives a third event;
identifies the account in the account datastore with which the third event is associated, wherein the account is the account with which the first event is associated;
makes a second business rules determination as to how to further process the third event;
the issue state maintenance engine:
generates a second state model according to the second business rules determination;
stores the second state model in the issue state model datastore;
the alert generation engine:
identifies the destination of the account in the alert registration datastore, wherein the destination is the destination with which the first event is associated;
determines a second expected response to an alert associated with the third event;
generates a second alert that includes a value sufficient to identify the second expected response;
sends the second alert on the stateless communication channel to the destination;
wherein if the event processing engine later receives a fourth event that includes the value sufficient to identify the second expected response, the issue state maintenance engine updates the second state model in accordance with the expected response.

3. The system of claim 1 further comprising an account management engine coupled to the account datastore and the alert registration datastore, wherein, in operation, the account management engine:
accepts input, including the destination, as data associated with the account;
saves the destination in the alert registration datastore.

4. The system of claim 1 further comprising an issue escalation engine coupled to the event processing engine, wherein, in operation:
the issue escalation engine makes an escalation determination as to whether to:
send an alert associated with the state model,
escalate an issue associated with the state model, or
close the issue associated with the state model;
the issue state maintenance engine updates the state model in accordance with the expected response and the escalation determination.

5. The system of claim 1 further comprising a private network, wherein the event processing engine, issue state maintenance engine, alert generation engine, account datastore, issue state model datastore, and alert registration datastore are inside the private network.

6. The system of claim 1 further comprising a business rules datastore coupled to the event processing engine, wherein, in operation, the event processing engine uses business rules in the business rules datastore to make the business rules determination as to how to further process the first event.

7. The system of claim 6 further comprising an account management engine coupled to the business rules datastore, wherein, in operation, the account management engine:
accepts input, including a business rule used to make the business rules determination;
saves the business rule in the business rules datastore.

8. The system of claim 1 further comprising a network interface coupled to the event processing engine and a network, wherein in operation the event processing engine receives the first event through the network interface from a device on the network.

9. The system of claim 1 further comprising a network interface coupled to the alert generation engine and a network, wherein in operation the alert generation engine sends the alert through the network interface to a device on the network.

10. The system of claim 1, wherein the account is a first account, the business rules determination is a first business rules determination, the state model is a first state model, the expected response is a first expected response, the alert is a first alert, and the destination is a first destination, further comprising:
an event aggregation engine coupled to the event processing engine;
a historical event datastore coupled to the event aggregation engine;
wherein, in operation:
the event processing engine:
receives a third event;
stores data associated with the third event in the historical event datastore;
receives a fourth event
identifies a second account in the account datastore with which the fourth event is associated;
the event aggregation engine:
identifies the third event stored in the historical event datastore as being associated with the fourth event;
makes a second business rules determination as to how to further process the third event and the fourth event;
the issue state maintenance engine:
generates a second state model according to the second business rules determination;
stores the second state model in the issue state model datastore;
the alert generation engine:
identifies a destination of the second account in the alert registration datastore;
determines a second expected response to an alert, wherein the second expected response is responsive to the third event and the fourth event;
generates a second alert that includes a value sufficient to identify the second expected response;
sends the second alert on a stateless communication channel to the second destination;
wherein if the event processing engine later receives a fifth event that includes the value sufficient to identify the second expected response, the issue state maintenance engine updates the second state model in accordance with the expected response.

11. A method comprising:
receiving at an event processing engine a first event;
identifying an account with which the first event is associated;
making a business rules determination as to how to further process the first event;
generating at an issue state maintenance engine a state model according to the business rules determination;
storing the state model;
identifying at an alert generation engine a destination of the account;
determining an expected response to an alert associated with the first event;
generating an alert that includes a value sufficient to identify the expected response;
sending the alert on a stateless communication channel to the destination;
updating the state model in accordance with the expected response if a second event that includes the value sufficient to identify the expected response is received.

12. The method of claim 11, wherein the business rules determination is a first business rules determination, the state model is a first state model, the expected response is a first expected response, the alert is a first alert, further comprising:
receiving at the event processing engine a third event;
identifying the account with which the third event is associated, wherein the account is the account with which the first event is associated;
making a second business rules determination as to how to further process the third event;
generating at the issue state maintenance engine a second state model according to the second business rules determination;
storing the second state model;
identifying at the alert generation engine the destination of the account, wherein the destination is the destination with which the first event is associated;
determining a second expected response to an alert associated with the third event;
generating a second alert that includes a value sufficient to identify the second expected response;
sending the second alert on the stateless communication channel to the destination;
updating the second state model in accordance with the expected response to the third event if a fourth event that includes the value sufficient to identify the second expected response is received.

13. The method of claim 11 further comprising:
determining at an issue escalation engine an escalation determination as to whether to:
send an alert reminder associated with the state model,
escalate an issue associated with the state model, or
close the issue associated with the state model;
updating the state model in accordance with the expected response and the escalation determination.

14. The method of claim 11 further comprising:
accepting input, including a business rule used to make the business rules determination;
saving the business rule.

15. The method of claim 11, wherein the account is a first account, the business rules determination is a first business rules determination, the state model is a first state model, the expected response is a first expected response, the alert is a first alert, and the destination is a first destination, further comprising:
receiving at the event processing engine a third event;
storing data associated with the third event as historical data;
receiving at the event processing engine a fourth event
identifying a second account with which the fourth event is associated;
identifying the third event stored as historical data as being associated with the fourth event;
making a second business rules determination as to how to further process the third event and the fourth event;
generating a second state model according to the second business rules determination;
storing the second state model;
identifying a destination of the second account;
determining a second expected response to an alert, wherein the second expected response is responsive to the third event and the fourth event;
generating a second alert that includes a value sufficient to identify the second expected response;
sending the second alert on a stateless communication channel to the second destination;
updating the second state model in accordance with the expected response if a fifth event includes the value sufficient to identify the second expected response.

16. A system comprising:
a means for receiving at an event processing engine a first event;
a means for identifying an account with which the first event is associated;
a means for making a business rules determination as to how to further process the first event;
a means for generating at an issue state maintenance engine a state model according to the business rules determination;
a means for storing the state model;
a means for identifying at an alert generation engine a destination of the account;
a means for determining an expected response to an alert associated with the first event;
a means for generating an alert that includes a value sufficient to identify the expected response;
a means for sending the alert on a stateless communication channel to the destination;
a means for updating the state model in accordance with the expected response if a second event that includes the value sufficient to identify the expected response is received.

17. The method of claim 16 further comprising:
a means for determining at an issue escalation engine an escalation determination as to whether to:
send an alert reminder associated with the state model,
escalate an issue associated with the state model, or
close the issue associated with the state model;
a means for updating the state model in accordance with the expected response and the escalation determination.

18. The system of claim 16 further comprising:
a means for accepting input, including a business rule used to make the business rules determination;
a means for saving the business rule.

19. The system of claim 16, wherein the business rules determination is a first business rules determination, the state model is a first state model, the expected response is a first expected response, the alert is a first alert, further comprising:
a means for receiving at the event processing engine a third event;
a means for identifying the account with which the third event is associated, wherein the account is the account with which the first event is associated;
a means for making a second business rules determination as to how to further process the third event;
a means for generating at the issue state maintenance engine a second state model according to the second business rules determination;
a means for storing the second state model;
a means for identifying at the alert generation engine the destination of the account, wherein the destination is the destination with which the first event is associated;
a means for determining a second expected response to an alert associated with the third event;
a means for generating a second alert that includes a value sufficient to identify the second expected response;
a means for sending the second alert on the stateless communication channel to the destination;
a means for updating the second state model in accordance with the expected response to the third event if a fourth event that includes the value sufficient to identify the second expected response is received.

20. The system of claim 16, wherein the account is a first account, the business rules determination is a first business rules determination, the state model is a first state model, the expected response is a first expected response, the alert is a first alert, and the destination is a first destination, further comprising:
a means for receiving at the event processing engine a third event;
a means for storing data associated with the third event as historical data;
a means for receiving at the event processing engine a fourth event
a means for identifying a second account with which the fourth event is associated;
a means for identifying the third event stored as historical data as being associated with the fourth event;
a means for making a second business rules determination as to how to further process the third event and the fourth event;
a means for generating a second state model according to the second business rules determination;
a means for storing the second state model;
a means for identifying a destination of the second account;
a means for determining a second expected response to an alert, wherein the second expected response is responsive to the third event and the fourth event;
a means for generating a second alert that includes a value sufficient to identify the second expected response;
a means for sending the second alert on a stateless communication channel to the second destination;
a means for updating the second state model in accordance with the expected response if a fifth event includes the value sufficient to identify the second expected response.
